(19) United States
(12) Patent Application Publication
(10) Pub. No.: US 2008/0250480 A1
(43) Pub. Date: Oct. 9, 2008

(54) METHOD AND SYSTEM FOR AN ELECTRONIC BANK SAFE DEPOSIT BOX

(75) Inventor: Hamid Meshkat, Markham (CA)

Correspondence Address: BERESKIN AND PARR, 40 KING STREET WEST, BOX 401, TORONTO, ON, M5H 3Y2, CA

(73) Assignee: Value Consulting Group Inc., Markham (CA)

(21) Appl. No.: 11/696,332

(22) Filed: Apr. 4, 2007

(51) Int. Cl. H04L 9/32

(52) U.S. Cl. 726/6

(57) ABSTRACT

A system and method for providing secure electronic storage in a plurality of electronic safes which each include a plurality of electronic compartments. The owner of each electronic safe can generate new compartments and determine who has access to each of the compartments in their electronic safe.

### FIELD

The embodiments described herein relate to the storage of electronic documents and, more particularly, to a system and method for providing secure storage for electronic documents within a plurality of compartments.

### BACKGROUND

The storage of important documents in a secure bank deposit box has been in practice for many decades. Many people today still rent a bank safe deposit box to store their important personal and business documents. The main reason for storing documents in such a way is to protect the documents from theft, fire, and other causes of loss. These documents could be major business agreements, property deeds, personal wills, insurance documents, product formulas, or any other important personal and business documents and information.

### SUMMARY

The invention provides in one aspect, a system for providing secure electronic storage to a plurality of customers, the system comprising:

a safe generation module for generating a plurality of electronic safes, wherein each electronic safe in the plurality of electronic safes has an associated customer identifier for identifying the customer controlling the electronic safe;
a compartment generation module for generating a plurality of compartments in each electronic safe;
a compartment management module for storing one or more electronic documents in one or more of the electronic compartments in a specified safe;
an access generation module for, for each electronic compartment in the specified safe:
i) defining at least one access condition; and
ii) storing, in association with the electronic compartment, at least one access holder identifier for identifying an access holder;
   an authentication module for determining if an authentication condition is met, the authentication module being operable to:
i) receive an authentication request from a user including identifying information; and
ii) verify the identity of the user based on the identifying information; and
   an access control module for, if the authentication condition has been met:
i) determining a user identifier associated with the user;
ii) granting access to a requested electronic compartment of a requested electronic safe if the at least one access condition for the requested electronic compartment is met, wherein the at least one access condition comprises a requirement that the user identifier be an access holder identifier stored in association with the requested electronic compartment;
iii) denying access to the requested electronic compartment if the at least one access condition for the requested electronic compartment is not met;
iv) for each electronic safe in the plurality of electronic safes, checking if the user identifier is the associated unique customer identifier for that electronic safe, and granting access to the compartment generation module, the compartment management module and the access generation module in relation to that electronic safe if the user identifier is the associated unique customer identifier for that electronic safe.

The invention provides in another aspect, a method of providing secure electronic storage to a plurality of customers, the method comprising:

(a) for each customer in the plurality of customers, receiving an application for an electronic safe;
(b) providing a plurality of electronic safes by, for each customer in the plurality of customers, granting an electronic safe to that customer, the electronic safe including a customer identifier identifying that customer;
(c) determining if an authentication condition has been met by:
(i) receiving an authentication request from a user including identifying information; and
(ii) verifying the identity of the user based on the identifying information;
   (d) if the authentication condition has been met, determining a user identifier associated with the user;
   (e) generating a plurality of electronic compartments for each electronic safe by, if the authentication condition has been met:
(i) receiving a request from the user to create a new electronic compartment in a requested electronic safe;
(ii) verifying that the user identifier matches the customer identifier of the requested electronic safe; and
(iii) if the user identifier matches the customer identifier of the requested electronic safe, creating the new electronic compartment in the requested electronic safe;
   (f) for each electronic compartment in the plurality of electronic compartments in each electronic safe in the plurality of electronic safes, defining at least one access condition;
   (g) for each electronic compartment in the plurality of electronic compartments in each electronic safe in the plurality of electronic safes, storing, in association with that electronic compartment, at least one access holder identifier identifying an access holder by, if the authentication condition has been met:
(i) receiving a request from the user to authorize access to a requested electronic compartment in the requested electronic safe by a specific access holder;
(ii) verifying that the user identifier matches the customer identifier of the requested electronic safe; and
(iii) if the user identifier matches the customer identifier of the requested electronic safe, storing, in association with the requested electronic compartment, the access holder identifier identifying the specific access holder; and
   (h) controlling access to the plurality of electronic safes by, if the authentication condition has been met:
(i) granting access to a requested electronic compartment of a requested electronic safe if the at least one access condition for the requested electronic compartment is met, wherein the at least one access condition comprises a requirement that the user identifier be an access holder identifier stored in association with the requested electronic compartment; and
(ii) denying access to the requested electronic compartment if the at least one access condition for the requested electronic compartment is not met.

Further aspects and advantages of the invention will appear from the following description taken together with the accompanying drawings.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of a secure storage system in accordance with an embodiment of the invention;

FIG. 2A is a block diagram of an exemplary access link of the secure storage system of FIG. 1;

FIG. 2B is a block diagram of another exemplary access link of the secure storage system of FIG. 1;

FIG. 2C is a diagram of example entries in the access link storage unit of the secure storage system of FIG. 1 which create a basic electronic safe;

FIG. 2D is a diagram of example entries in the access link storage unit, compartment content storage unit and document storage unit of the secure storage system of FIG. 1;

FIG. 2E is a block diagram of an exemplary electronic safe in the secure storage system of FIG. 1;

FIG. 3 is a flowchart diagram illustrating a method of creating a new access link in accordance with an aspect of an embodiment of the invention;

FIG. 4 is a flowchart diagram illustrating a method of providing access to an electronic compartment of an electronic safe in accordance with an aspect of an embodiment of the invention;

FIG. 5 is a diagram of example entries in the access link storage unit, compartment content storage unit and document storage unit of the secure storage system of FIG. 1;

FIG. 6 is a diagram of example electronic safes, electronic compartments, and electronic documents in the secure storage system of FIG. 1;

FIG. 7 is a flow chart diagram illustrating a method of generating an electronic safe in accordance with an aspect of an embodiment of the invention;

FIG. 8 is a flow chart diagram illustrating a method of generating a new electronic compartment in accordance with an aspect of an embodiment of the invention; and

FIG. 9 is a diagram of example entries in the access link storage unit, compartment content storage unit and document storage unit of the secure storage system of FIG. 1.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

The ability to store information electronically has changed the way we access information. For example, the internet now allows us to access our electronic documents from anywhere in the world. As a result, information such as credit card numbers, traveler cheque information, or detailed passport information can be stored electronically and accessed in the case of emergency from any location with internet access. These documents, however, must be safe guarded in a secure storage system in order to prevent unauthorized people from gaining access to sensitive information.

On the other hand, the owner of electronic information may wish to allow certain authorized access holders to view, update, upload, download or create their electronic information. For example, a person may wish to allow an attorney to create, update, or view a personal will or other legal documents. Similarly, a person may wish to allow the family doctor or an insurance company have access to important medical records, or to allow property registration authorities to update property deeds and similar property records.

Systems currently exist which provide secure storage for electronic documents and information. These systems, however, do not provide an easy and versatile way to control who has access to different documents in an electronic secure storage.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

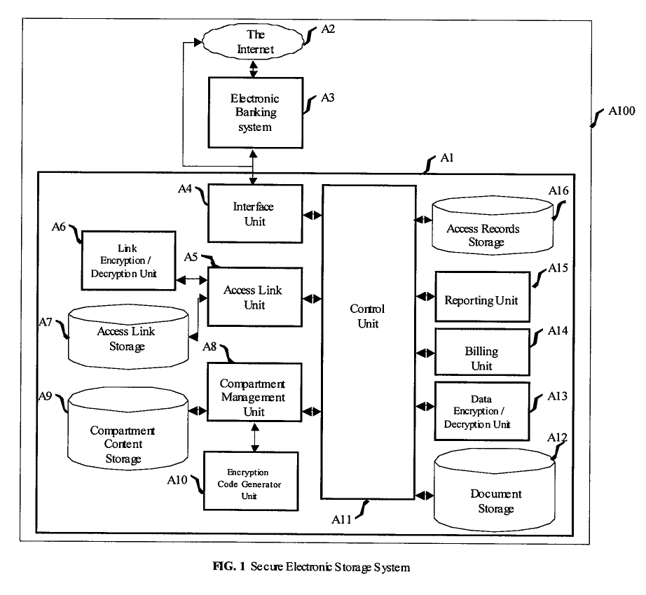

Reference is first made to FIG. 1, which illustrates a secure storage system A100 according to one exemplary embodiment of the invention. The secure storage system A100 includes an electronic safe system A1 connected to an electronic money transfer system A3, such as an electronic banking system, through a data network A2, such as the Internet.

While only one electronic money transfer system A3 is depicted in FIG. 1, the secure storage system A100 may contain any number of electronic money transfer systems A3 which are all connected to the electronic safe system A1.

The electronic safe system A1 may contain any number of individual electronic safes. Each electronic safe in electronic safe system A1 will have a unique safe identifier which differentiates it from any other safes which may exist in the electronic safe system A1. Each electronic safe is conceptually divided into a number of electronic compartments, each with a unique compartment identifier.

A document storage unit A12 contains any number of electronic documents, each having a unique document identifier and a unique encryption code. Each electronic document in the document storage unit A12 may be associated with one or more electronic compartments.

A compartment content storage unit A9 is used to keep track of the compartments with which each document is associated. It stores a number of records, each of which includes a safe identifier, a compartment identifier, a document identifier, a document name, and a document encryption code. If a document is associated with more than one compartment then there will be more than one record with the corresponding document identifier stored in the compartment content storage unit A9.

A control unit A11 controls the operation of the electronic safe system A1.

A compartment management unit A8, along with the control unit A11, manage the documents stored in the document storage unit A12. Each time a new document is added to the document storage unit A12, first the compartment management unit A8 requests a unique encryption code for the document from an encryption code generator unit A10. The compartment management unit A8 then stores the document identifier and the name for the new document as well as the generated encryption code in the compartment content storage unit A9 along with an electronic compartment identifier with which the new document is to be associated. The compartment management unit A8 then sends the document identifier and the encryption code to the control unit A1.

Once the control unit A11 receives the document identifier and its encryption code from the compartment management unit A8, the control unit A11 sends the document and its encryption code to a data encryption/decryption unit A13 which is used to encrypt and decrypt documents stored in the document storage unit A12 according to the encryption code generated by the encryption code generator unit A10 for that document. The control unit A11 then stores the encrypted document and its document identifier in the document storage unit A12.

When an electronic document is to be retrieved from document storage unit A12, the compartment management unit A8 will retrieve the appropriate document identifier and encryption code from compartment storage unit A9 and send to the control unit A11. The control unit A11 will then retrieve the encrypted document from the document storage unit A12 and send it, with its unique encryption code, to the data encryption/decryption unit A13 to be decrypted.

An interface unit A4 receives and transmits electronic data, such as electronic documents and authentication and billing information, to and from the electronic money transfer system A3 and the data network A2.

An access link storage unit A7 stores a number of access links, each giving a specific user a specific type of access to a specific compartment. The structure of these access links will be discussed in further detail in relation to

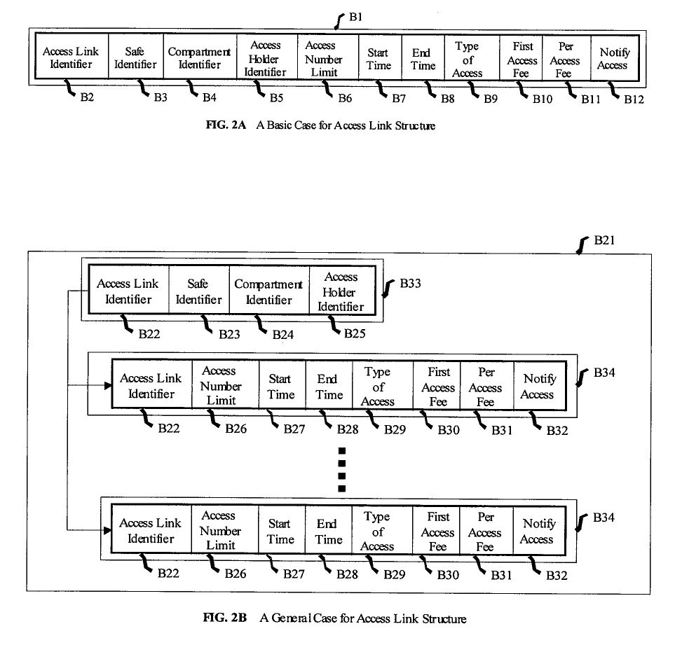

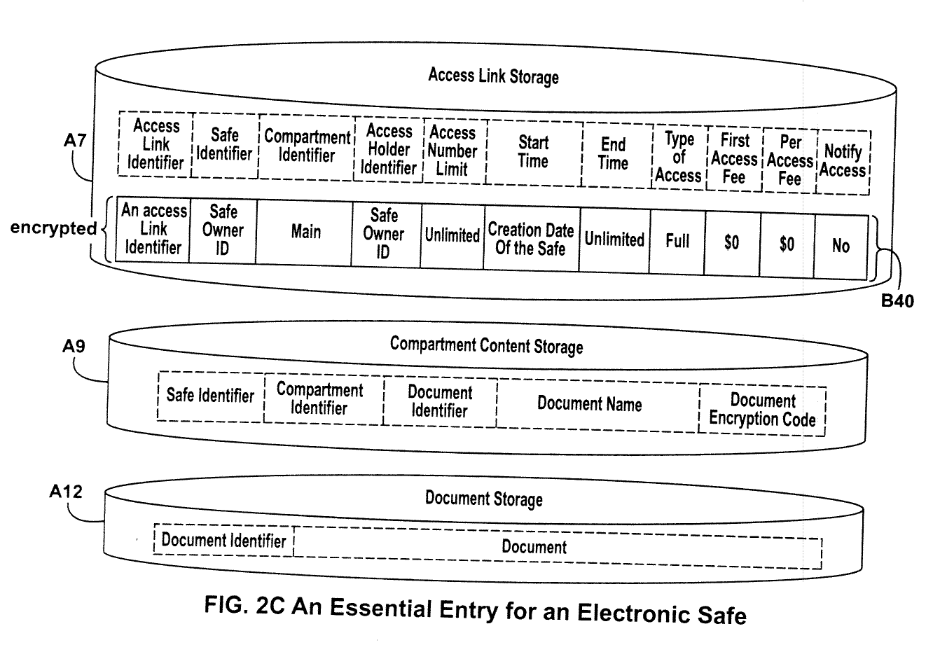

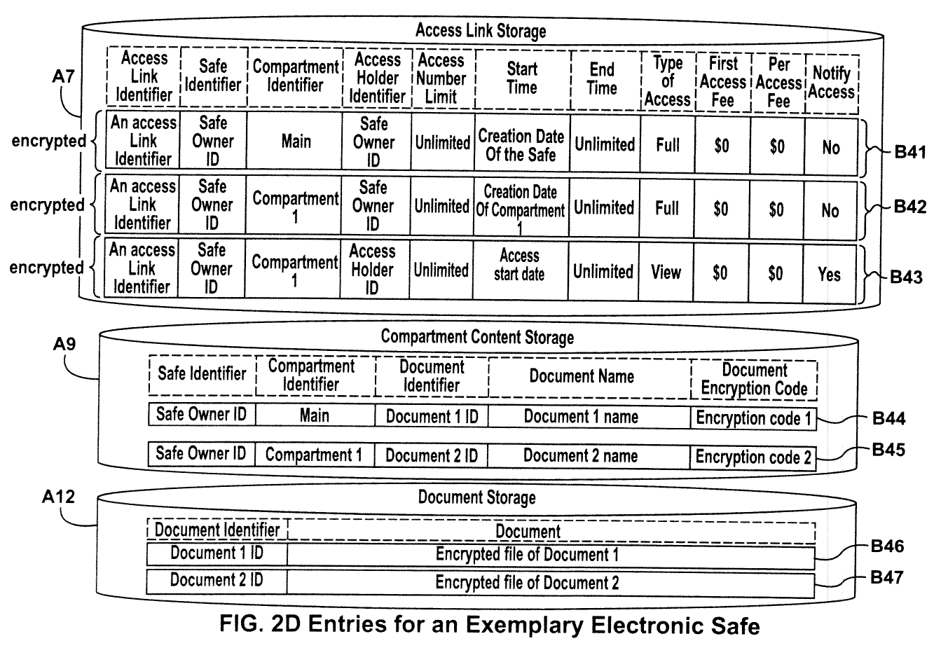

FIGS. 2A and 2B. The access links can be encrypted and decrypted using a link encryption/decryption unit A6.

An access link unit A5 retrieves access links from and stores access links in the access link storage unit A7. The access link unit A5 is also responsible for creating new access links and deleting access links from the access link storage unit A7 which are no longer needed as well as modifying access links when necessary.

An access records storage unit A16 stores access information. Each time an attempt is made to access a compartment in an electronic safe, including those attempts which are denied, a record of that attempt is stored in the access records storage unit A16.

One or more of the access links stored in the access link storage unit A7 may indicate that the owner of a particular electronic safe wishes to receive a notification each time an access attempt is made to that electronic safe using that particular access link. If so, an access reporting unit A15 will send an electronic notification, such as an email, to the owner of the particular electronic safe each time such an access attempt is made. The structure of these access links will be discussed in greater detail in relation to FIGS. 2A and 2B.

The access reporting unit A15 can also send access reports to a safe owner upon request. Upon receiving a request from the safe owner via the interface unit A4 and the control unit A11, the access reporting unit A15 queries the records stored in the access record storage unit A16 and sends the results back to the interface unit A4, through the control unit A11, for presentation to the safe owner.

Each access link stored in the access link storage A7 may include one or more access fees. When an access link containing an applicable access fee which is greater than zero is retrieved by the access link unit A5, the access link unit A5 sends the access fee information to a billing unit A14 thorough the control unit A11. The billing unit A14 creates billing records according to the amount set by the safe owner and the format accepted by the electronic money transfer system A3. It then sends the billing records through the control unit A11 and the interface unit A4 to the electronic money transfer system A3 so that the access fee amount may be charged to the user and deposited into an account owned by the safe owner.

The electronic safe system A1, through the electronic money transfer system A3, may periodically withdraw a safe administration fee from an account held by a safe owner as payment for the electronic safe service they provide. If there are not enough funds in the safe owner's account to cover the safe administration fee, the electronic safe system A1 may prevent the safe owner or other access holders from accessing the electronic safe until the safe administration fees have been paid.

Referring now to FIG. 2A, a block diagram of an exemplary access link B1 is shown. The access link B1 includes an access link identifier field B2, a safe identifier field B3, a compartment identifier field B4, an access holder identifier field B5, an access number limit field B6, a start time field B7, an end time field B8, a type of access field B9, a first access fee field B10, a per-access fee field B11, and a notify access field B12.

The link identifier field B2 contains a unique identifier for the access link B1. The safe identifier field B3 contains a safe identifier which uniquely identifies an electronic safe within the electronic safe system A1. This identifier could be the same as an account number of the safe owner in the electronic money transfer system A3 or it could be any unique number or combination of symbols identifying the electronic safe. The compartment identifier field B4 contains an identifying name or combination of symbols which is unique within the identified electronic safe. The combination of the safe identifier and the compartment identifier uniquely identifies a compartment within the electronic safe system A1.

The access holder identifier field B5 contains an access holder identifier which identifies the user to whom access is given, called the access holder. The access holder identifier may be the safe identifier of a safe belonging to the access holder, a bank account number of the access holder in the electronic money transfer system A3 or any other unique number or combination of symbols identifying the access holder.

The access number limit field B6 restricts the number of times which the access link B1 can be used to access the identified compartment. The access number limit field B6 may be set to a specific number or set to “unlimited” (e.g. a large number known to the system as unlimited) indicating an unlimited number of accesses. If this field is not set to “unlimited”, each time a successful access is made by the access holder using this access link, the access limit number field B6 is reduced by one.

The start time field B7 contains the date and time at which the access link B1 becomes valid. It can be the present date and time when authorization is granted or any specified date and time thereafter.

The end time field B8 is the date and time after which the access link B1 is no longer valid and can no longer be used to access the identified compartment. The end time field B8 will normally contain a date and time after the date and time stored in start time field B7. The end time field B8 may also be set to “unlimited” (e.g. a very large date known to the system as unlimited date and time) indicating that the access link never expires.

The type of access field B9 contains the type of access for which the access holder is authorized. This could be any type of access such as viewing, uploading, updating, creating, downloading, or deleting. The type of access field B9 may also be set to “full” indicating that the all access types are granted to the access holder for the identified compartment. The type of access field B9 may comprise a number of subfields, each one indicating whether a specific type of access is granted or not.

The first access fee field B10 contains an access fee, usually set by the safe owner, to be charged to the access holder for accessing the identified compartment the first time this access link B1 is used. Once the access holder accesses the identified compartment for the first time and the first access fee is charged, the first access fee is reset to zero.

The per-access fee field B11 contains an access fee, usually set by the safe owner, to be charged to the access holder for accessing the identified compartment using this access link B1 after the first access.

The notify access field B12 contains a flag which, if set to “yes”, indicates that the safe owner wishes to be notified each time the access holder identified in the access holder identifier field B5 attempts to access the compartment identified in the compartment identifier field B4 using this access link B1.

Referring now to FIG. 2B, a block diagram of another exemplary access link B21 is shown. The access link B21 is similar to the access link B1 except that the access link B21 allows a safe owner to set a different value in the access number limit field B26, the start time field B27, the end time field B28, the first access fee field B30, the per-access fee field B31, and the notify access field B32 for each type of access identified in type of access field B29.

In this embodiment of an exemplary access link, the access fields are located in multiple records. The safe identifier field B23, the compartment identifier field B24, and the access holder identifier field B25 are part of the main record B33 and occur only once. The access number limit field B26, the start time field B27, the end time field B28, the type of access field B29, the first access fee field B30, the per-access fee field B31, and the notify access field B32 occur in each instance of a secondary record B34. There may be as many instances of the secondary record B34 as there are different types of access the safe owner can to grant to the access holder. The main and secondary records B33 and B34 are referenced to each other through the access link identifier field B22 which is included in both types of records.

It should be noted that other access link structures can be used, including any number of records, referenced to each other in some manner, and any number of access fields. For simplicity in explaining the remaining components of the secure storage system A100, however, it will be assumed that the access links discussed hereafter have the structure of the access link B1 of FIG. 2A.

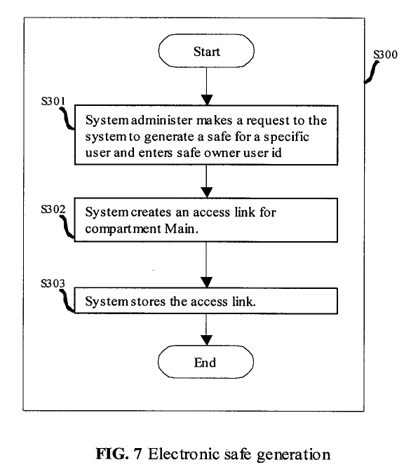

Reference will now be made to FIG. 2C which depicts entry in the access link storage unit A7 used to create an exemplary electronic safe. The method used to create a new electronic safe will be discussed in relation to FIG. 7. This exemplary safe has only one compartment, the Main compartment, and this compartment does not contain any electronic documents. In this example, the access link storage unit A7 includes only one access link B40 providing access to the Main compartment to the owner of the safe. As will be discussed in relation to FIG. 7, this is the only entry required to create an electronic safe.

Reference will now be made to FIG. 2D which depicts an exemplary access link storage unit A7, compartment content storage unit A9 and document storage unit A12 for an exemplary electronic safe. The access link storage unit A7 includes three access links B41, B42, and B43. The first two access links B41 and B42 provide access to the safe owner of the electronic safe to the ‘Main’ and ‘compartment 1′ compartments, respectively. The third access link B43 provides access to an access holder to the ‘compartment 1’ compartment.

The compartment content storage unit A9 includes two records. B44 and B45. The first record B44 indicates that there is a document with identifier ‘Document 1 ID’ in the Main compartment of the electronic safe. The second record B45 indicates that there is another document with identifier ‘Document 2 ID’ in compartment 1 of the electronic safe. There are also two records in the document storage unit A12. The first record B46 makes reference to the encrypted file for Document 1 and the second record B47 makes reference to the encrypted file for Document 2. Both of these documents are stored in the document storage unit A12.

Reference will now be made to FIG. 2E which depicts a block diagram of the exemplary electronic safe B50 discussed with reference to FIG. 2D. The electronic safe B50 has an electronic safe identifier B51 which is referenced by the two compartments: the Main compartment B53 and compartment 1 B57. The arrows B52, B56, and B60 represent the access links B41, B42, and B43 of FIG. 2D respectively. The arrows B54 and B58 represent the records B44 and B45 of FIG. 2D respectively. The documents B55 and B59 represent the record entries B46 and B47 of FIG. 2D respectively.

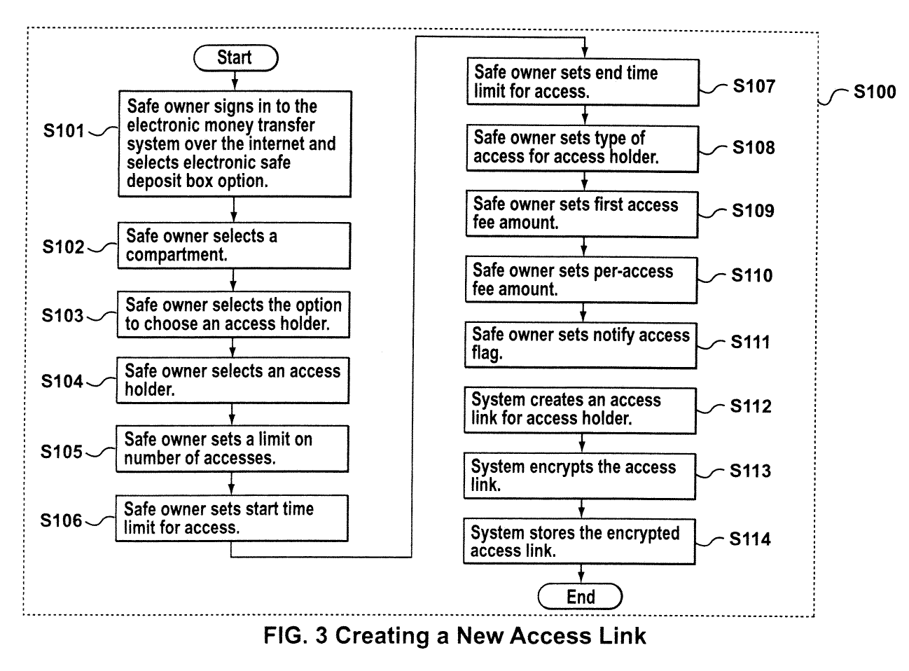

Referring now to FIG. 3, a flowchart diagram is shown illustrating a method S100 for creating a new access link in the access link storage unit A7 of the electronic safe system A1.

The method S100 begins at step S101 where the owner of a safe B50 signs into the electronic money transfer system A3 over the internet A2 by entering identifying information using a sign-in screen. This identifying information may consist of a user identifier, such as a bank client card number, and a password or can include additional authentication information such as answers to pre-set questions, a security token number, biometric information or any other information which can be used to identify the safe owner. The electronic money transfer system A3 will use the identifying information to authenticate the identity of the safe owner.

Once the safe owner has been authenticated by the electronic money transfer system A3, he or she will be presented with a list of electronic compartments in their electronic safe B50. Here, we will assume that each safe owner owns only one electronic safe B50 but it should be noted that the same method could be applied to a system in which some safe owners may own more than one electronic safe B50 in the secure storage system A100. At step S102, the safe owner selects one of the electronic compartments from the list of compartments in his or her electronic safe.

The safe owner will then be presented with a list of possible maintenance activities which may be performed within their electronic safe B50. At step S103, the safe owner selects the option for providing access to an access holder for the selected compartment.

The safe owner may then be presented with a list of all possible access holders. Here, we will assume that this is a list of other safe owners who have an electronic safe B50 in the secure storage system A100 but it could be any list of users known to the secure storage system A100 in some way. The list of possible access holders may be created once and maintained by the electronic safe system A1 or, alternatively, the list may be created each time it is required by, for example, searching the access links B1 in access link storage unit A7. At step S104, the safe owner selects an access holder from the list.

Alternatively, the safe owner may be presented with a search screen in which they can search for a particular access holder based on one or more characteristics or they may be given the option to enter an access holder identifier directly.

Once the safe owner has selected an access holder, the information to be stored in the other fields of the access link B1 must be entered. At step S105, the safe owner sets the number of accesses for which the access link B1 is valid to a finite number or to “unlimited.” This value will be stored in the access number limit field B6. At step S106, the safe owner sets the starting date and time at which the access link B1 becomes valid, to be stored in the start time limit field B7. At step S107, the safe owner sets the end date and time at which the access link B1 expires, to be stored in the end time limit field B8. At step S108, the safe owner sets the type of access to be granted to the access holder, to be stored in the type of access field B9.

If the safe owner wants to impose an access fee to be paid by the access holder for the first time the compartment is accessed by the access holder using this access link, the amount of this fee is set by the safe owner at step S109. This value will be stored in the first access fee field B10. If no fee is required for the first access, the first access fee field will be set to zero.

If the safe owner wishes to impose an access fee to be charged each time the compartment is accessed by the access holder after the first access has occurred, the amount of this fee is set by the safe owner at step S110. This value will be stored in the per-access fee field B11. If no per-access fee is required, this field will be set to zero.

If the safe owner wishes to receive an electronic notification, such as an email, whenever the access holder accesses the compartment using this access link, the safe owner will set the value of the notify access field B12 to “yes” at step S111. Otherwise, the notify access field B12 will be set to “no.”

At step S112, the interface unit A4 sends all the information collected from the safe owner to the control unit A11. The control unit A11 then sends the information to the access unit A5 which assigns a unique access link identifier and creates the desired access link B1. The new access link is then sent to the link encryption/decryption unit A6 to be encrypted at step S113. Finally, at step S114, the encrypted access link B1 is stored in the access link storage unit A7.

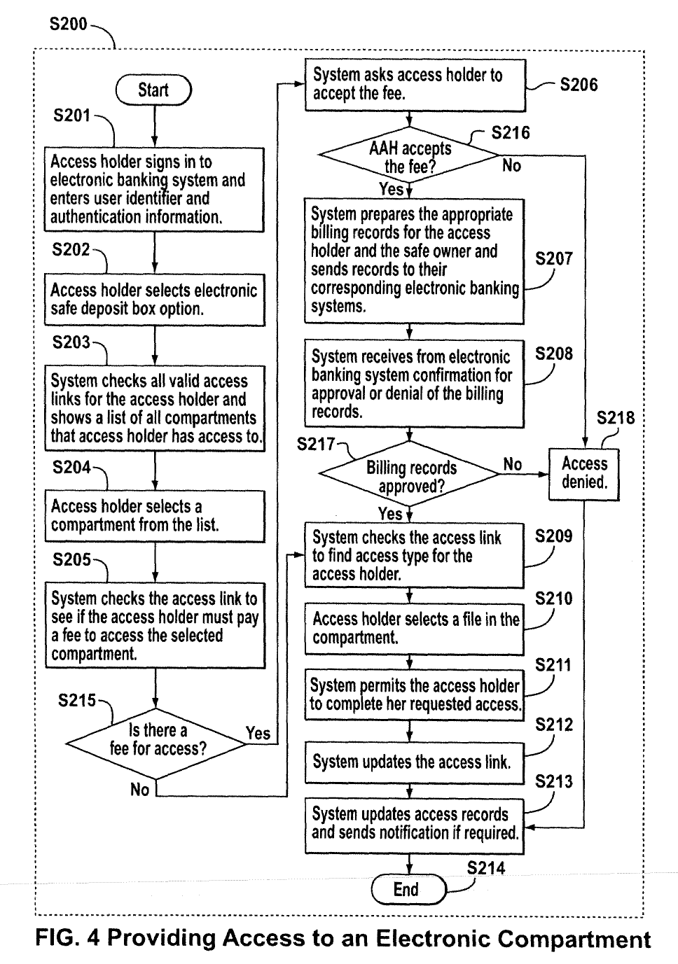

Referring now to FIG. 4, a flowchart diagram is shown illustrating a method S200 used to provide access to an electronic compartment of an electronic safe B50 to an access holder.

At step S201, the access holder signs in to the electronic money transfer system A3 as described above with reference to step S101 of method S100. The access holder then selects, at step S202, the electronic safe deposit box option from a list of services available through the electronic money transfer system A3.

At step S203, the electronic safe system A1 compiles a list of all electronic compartments to which the access holder has access. First, the control unit A11 receives an access holder identifier from the interface unit A4 and sends it to the access link unit A5. The access link unit A5 searches the access link storage unit A7 in order to find all access links with the given access holder identifier. Since all the access links in the access link storage unit A7 are encrypted, each access link may be decrypted before being searched. Alternatively, the access link unit A5 may encrypt the access holder identifier using the link encryption/decryption unit A6 and then check the encrypted access holder identifier against the encrypted access links B1.

Once the access link unit A5 has finished searching, it will send all matching access links B1 to the link encryption/decryption unit A6 to be decrypted, if they have not already been decrypted during the search. The access link unit A5 will then send the decrypted matching access links B1 to the control unit A11. The control unit A11 then sends the information to the interface unit A4 for presentation to the user/access holder. The interface unit will present the user with a list of all compartments for which they have a valid access link B1. This list will include all the electronic compartments in safes owned by the access holder as well as any electronic compartments in safes owned by other safe owners to which the access holder has been given access using the method S100 described in FIG. 3. For the purposes of this example, we will assume that there is only one access link per access holder for each compartment in an electronic safe B50.

At step S204, the access holder selects an electronic compartment from the list of all compartments to which the access holder has access.

At step S205, the interface unit A4 sends the safe identifier and compartment identifier of the selected compartment to the control unit A11. The control unit A11 then checks the appropriate access link B1 in order to determine whether or not an access fee is required. If an access fee is not required, then the method S200 continues from step S215 to step S209.

If an access fee is required, whether it is a first access fee or it is a per-access fee, the control unit A11 sends the fee information to the interface unit A4 to be presented to the access holder at step S206. The access holder is given the opportunity to accept or reject the fee. If the access holder rejects the fee at step S216, the interface unit A4 will deny access to the access holder at step S218 and send the information to control unit A11 which will archive the attempted access at step S213 and send a notification to the safe owner if required. If the access holder accepts the fee at step S216, the interface unit A4 sends the response to the control unit A11 which sends the access holder identifier, the safe identifier, and the fee amount to the billing unit A14 and the method S200 proceeds to step S207.

At step S207, the billing unit A14 prepares billing records according to the formats accepted by the electronic money transfer system A3 and sends those records through the control unit A11 and the interface unit A4 to the electronic money transfer system A3.

At step S208, the interface unit A4 receives a response from the electronic money transfer system A3 and passes this response to the control unit A11. If, at step S217, the response indicates that the billing records were approved, which may mean that the access fee has been successfully deducted from an account owned by the access holder and deposited to an account owned by the safe owner, then the control unit A11 proceeds to step S209. If, at step S217, the response indicates that the billing records were not approved, access to the selected compartment is denied at step S218. An appropriate message may also be presented to the access holder indicating the reason for the denied access. The method S200 then proceeds to step S213.

At step S209, the control unit A11 sends the compartment identifier B4 and the safe identifier B3 of the appropriate access link B1 to the compartment management unit A8. The compartment management unit A8 then queries all records stored in the compartment content storage unit A9 and finds all records that have the given safe identifier and compartment identifier. These records, containing the document identifier, document name and encryption code for each document in the requested electronic compartment, are then sent back to the control unit A1.

Also at step S209, the control unit A11 checks the type of access field B9 of the appropriate access link B1 to determine the type of access authorized. The control unit A11 sends the list of document names and authorized access types to the interface unit A4 for presentation to the access holder.

At step S210, the access holder selects a document from the list of document names and a type of access from the list of authorized access types.

At step S211, the control unit A11 uses the document identifier of the document selected at step S210 to retrieve the document from the document storage unit A12. The control unit A11 then sends the document, along with its encryption code, to the data encryption/decryption unit A13 to be decrypted. The control unit A11 then performs an action corresponding to the access holder's requested access and presents the result to the access holder through the interface unit A4.

At step S212, the control unit A11 checks the appropriate access link B1 to determine whether it needs to be updated. For example, if the access limit number field B6 of the appropriate access link B1 is not unlimited, that limit will be reduced by one. Similarly, if this is the first access by the access holder to the identified compartment and a first access fee greater than zero has been successfully deducted from the access holder account, the first access fee will be reduced to zero. The modified access link will be sent to the access link unit A5 to be encrypted by the link encryption/decryption unit A6. The modified, encrypted access link B1 will then be stored in the access link storage unit A7, replacing the old access link.

At step S213, the control unit A11 prepares access information including, for example, the access holder identifier, the time and date of the access, the document identifier, and the type of access, and sends this information to the access records storage unit A16 to be archived. If the access link indicates that an access notification is required by the safe owner, the reporting unit A15 will send an electronic notification to the safe owner including the access information.

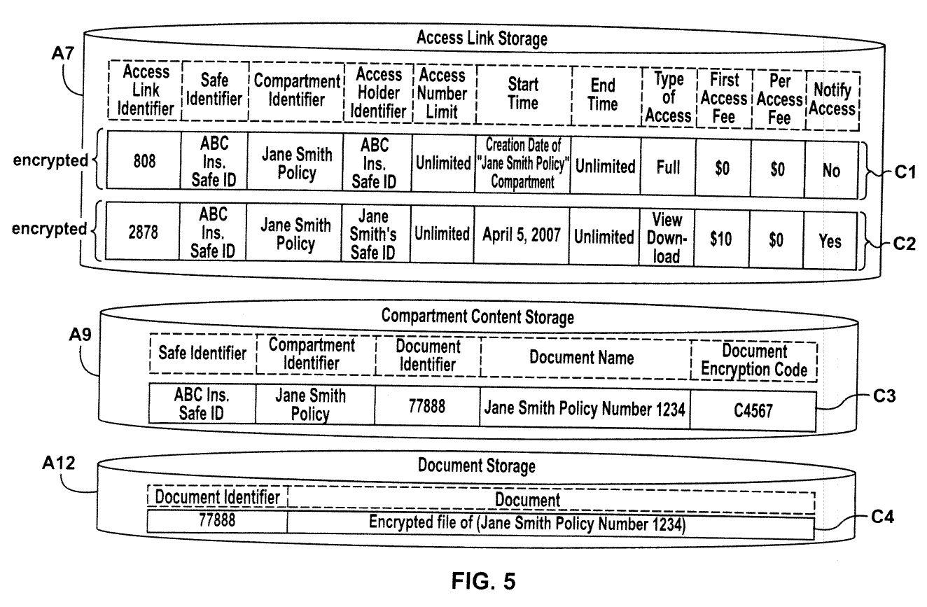

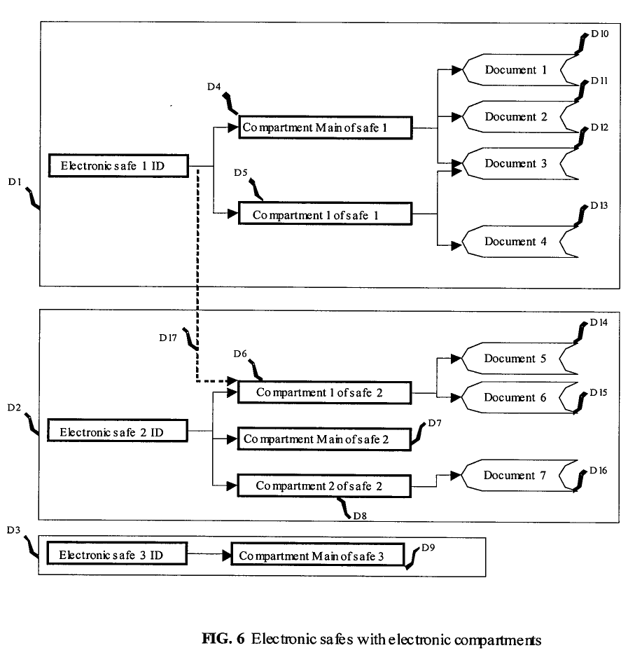

Reference will now be made to FIG. 5 which depicts an exemplary access link storage unit A7, compartment content storage unit A9 and document storage unit A12. The access link storage unit A7 includes two encrypted access links, one for a safe owner (C1) and one for an access holder who is not the owner of the safe (C2). FIG. 5 also depicts an example of a record C3 in the compartment content storage unit A9 and a document C4 in the document storage unit A12.

In this example, ABC Insurance has saved Jane Smith's insurance policy in the ABC Insurance electronic safe in an electronic compartment called “Jane Smith Policy.” ABC Insurance has provided access to the insurance policy to Jane Smith with access link C2.

In this example, each access holder is also a safe owner of an electronic safe and the access holder identifier for a particular access holder will be the safe identifier of the access holder's safe.

The first access link C1 is for the safe owner and, hence, the safe identifier and the access holder identifier are the same. According to this access link C1, ABC insurance has full access to the “Jane Smith Policy” compartment for an unlimited amount of time and an unlimited number of accesses at no cost and access notification is not required. The owner of a safe B50 will normally have an access link such as this one for each compartment in their safe B50.

The next access link C2 was created by ABC Insurance for Jane Smith. This access link C2 gives Jane Smith access to view or download any document in the “Jane Smith Policy” compartment in ABC Insurance's electronic safe after Apr. 5, 2007 upon paying a $10 to ABC Insurance for the first access. Jane Smith is entitled to an unlimited number of accesses with no cost thereafter and there is no expiry date. By setting the notify access field B12 to “yes”, ABC Insurance has requested the electronic safe system A1 to send an electronic notification to ABC Insurance whenever Jane Smith accesses this compartment.

ABC Insurance has placed one document into the “Jane Smith Policy” compartment. The record C3 in the compartment content storage unit A9 shows the document identifier, document name, and the encryption code used for this document. The electronic document named “Jane Smith Policy Number 1234” is encrypted using this document encryption code and stored in the document storage unit A12.

Reference will now be made to FIG. 6, which shows a diagram depicting examples of three electronic safes, D1, D2, and D3. The first electronic safe D1 has two electronic compartments D4 and D5. The second electronic safe D2 has three electronic compartments D6, D7, and D8. The third electronic safe D3 has one electronic compartment D9. The electronic compartments D4-D9 contain various electronic documents D10-D16.

Each electronic safe D1, D2, and D3 has a compartment called “Main.” This Main compartment is automatically created when the electronic safe D1, D2, and D3 is created. When generating a new safe D1, D2, and D3 and its Main compartment, the system needs to create at least one access link giving access to the Main compartment to the safe owner. The third electronic safe D3, including its Main compartment D9, is a newly created electronic safe with no electronic documents in it.

New compartments can be generated by creating a new access link for the safe owner for the new compartment and storing the new access link in the access link storage unit A7. For example, the second electronic safe D2 in FIG. 6 has two electronic compartments D6 and D8 in addition to a Main compartment D7. This means that there must be at least three access links for the safe owner of the second electronic safe D2 stored in the access link storage unit A7.

In this example, the safe owner of the second electronic safe D2 has authorized the safe owner of the first electronic safe D1 to have access to one of the electronic compartments D6 by providing an access link D17. This access link is depicted by a dashed line because it may not provide full access to the electronic compartment D6. The electronic compartment D6 contains two documents D14 and D15. Both of these documents are accessible by the safe owner of the first safe D1 as well as by the safe owner of the second safe D2.

Electronic documents stored in the document storage unit A12 of an electronic safe can be put in an electronic compartment by creating a record in the compartment content storage unit A9 of the safe. For example, there must be three records in the compartment content storage unit A9 indicating that there are three documents D10, D11, and D12 in the Main compartment D4 of the electronic safe D1.

The same electronic document can be placed in more than one compartment. For example, in FIG. 6, electronic document D12 has been placed in both compartments D4 and D5 of the first safe D1. Accordingly, there must be two corresponding records in compartment content storage unit A9 for the first safe D1, one linking the document D12 to the Main compartment D4 and one linking the document D12 to the other compartment D5.

It should be noted that, although the electronic document D12 is in two compartments, there is only one instance of the document D12 stored in the document storage unit A12.

It should also be noted that the Main compartment of an electronic safe may be empty even where there are documents in other compartments of the safe. For example, in FIG. 6, there are no documents placed in the Main compartment D7 of the second safe D2 but there are two documents D14 and D15 in the first compartment D6 and one document D16 in the second compartment D8 of the same safe D2.

Referring now to FIG. 7, a flow chart is shown illustrating the steps for a method S300 used to generate an electronic safe B50 within the secure storage system A100.

New electronic safes are normally generated by a system administrator. At step S301, the system administration requests the creation of a new electronic safe B50 for a specific electronic safe owner including the safe owner's user identifier. In the case where the electronic money transfer system is an electronic banking system and all safe owners are also customers of the bank, the user identifier could be the safe owner's bank account number or any other identifier that the bank uses to uniquely identify this individual.

At step S302, the electronic safe system A1 creates an access link B1 for the safe owner for the Main compartment of the new safe B50. The access holder field B5 of this new access link B1 will set to be the safe owner's user identifier. The access limit number field B6 and the end time limit field B8 of the new access link B1 will be set to “unlimited”. The start time limit field B7 of the new access link B1 will be the time at which the safe is created. The type of access field B9 of the new access link B1 will be set to “full,” the access fee fields B10 and B11 will be set to zero and the notify access field will be set to “no.”

At step S303, the newly created access link is encrypted by the link encryption/decryption unit A6 and stored in the access link storage unit A7.

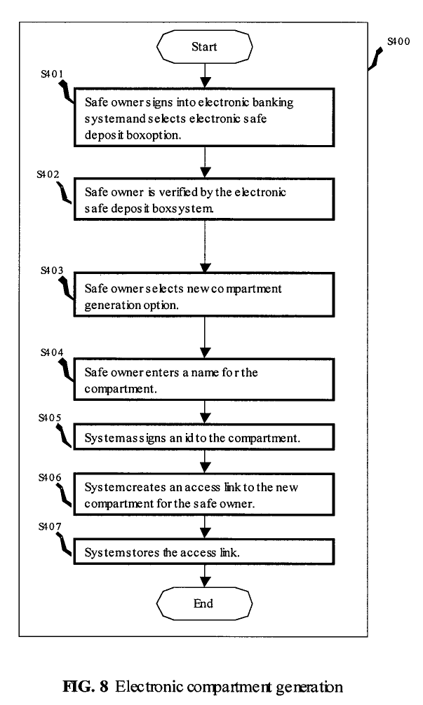

Referring now to FIG. 8, a flow chart is shown illustrating the steps for a method S400 used to generate a new electronic compartment in an electronic safe B50 within the secure storage system A100.

At step S401, the safe owner signs into the electronic money transfer system A3 by providing the identifying information required by that system. The electronic money transfer system A3 then authenticates the safe owner and the safe owner selects a safe deposit box option from a list of services available through the electronic money transfer system A3.

At step S402, the safe owner is verified by the electronic safe system A1 to be a valid safe owner by checking the access link storage unit A7 of each electronic safe B50 to determine whether an access link B1 exists for a Main compartment of a safe belonging to the safe owner. If such an access link exists, the safe owner is then confirmed to be a valid safe owner.

A list of possible actions is then presented to the safe owner. At step S403, the safe owner selects the option for creating a new compartment. At step S404, the safe owner enters a new name for the new compartment. The electronic safe system A1 then checks to ensure that the new name is not the same as the name of any other compartment in the safe B50. If the new name is the same as a name for an existing compartment, the safe owner is prompted to enter a different name.

At step S405, a compartment identifier is assigned to the new compartment. At step S406, a new access link is created giving the safe owner unlimited access to the new compartment and, at step S407, the newly created access link is encrypted and stored in the access link storage unit A7.

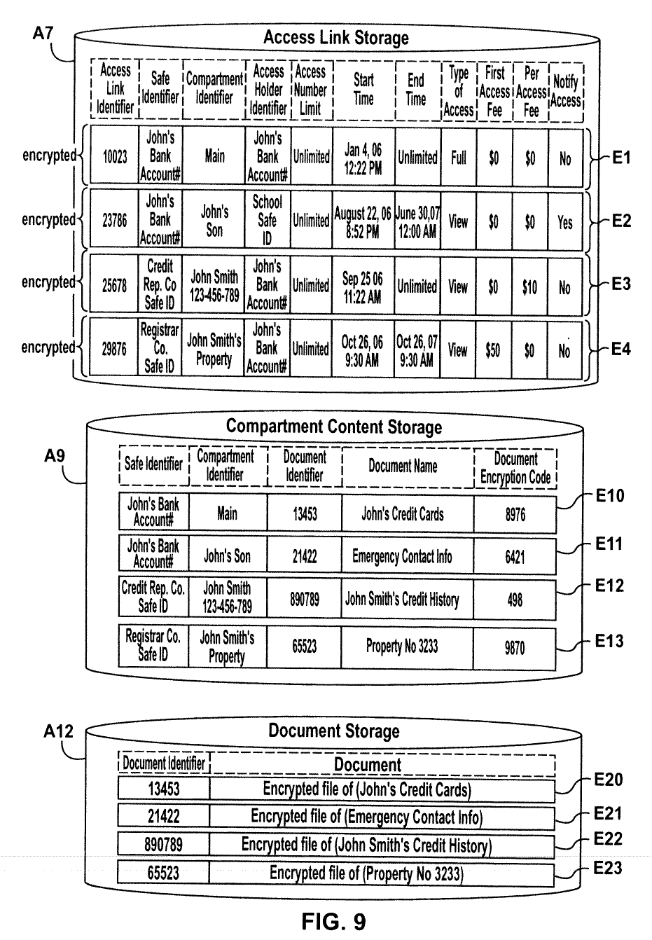

Reference will now be made to FIG. 9 which depicts another exemplary access link storage unit A7, compartment content storage unit A9 and document storage unit A12. The access link storage unit contains four exemplary access links E1, E2, E3, and E4. The compartment storage unit A9 contains four records E10, E11, E12, and E13. The document storage unit A12 contains four documents E20, E21, E22, and E23. It should be noted that the access link storage unit A7 will also contain other access links which are not shown in FIG. 9.

The first access link E1 in the access link storage unit A7 relates to the Main compartment of an electronic safe owned by a safe owner ‘John.’ The safe identifier and the access holder identifier are John's bank account number with the electronic money transfer system A3. In this example, John has not given access to any other access holders for the Main compartment of his safe. The compartment, in this example, contains John's credit card information, which he does not intend to share with others. If he does need to share this information, for example if he needs to report the theft of his credit cards, in this exemplary embodiment he can access his personal safe and retrieve the information from any location which has internet access available.

The second access link E2 in the access link storage unit A7 provides access to another electronic compartment in John's safe which is named after John's son. This compartment, in this example, contains the emergency contact information for John's son. The school which John's son attends has provided John with the school's electronic safe identifier and John has used this information to create an access link which provides access for the school to view the contents of the ‘John’s son’ compartment. John has provided this access at no cost and has set the access expiry date to a date after which the school year will have ended and his son will have left that school. In this exemplary embodiment, while John's son attends the school, the school authorities will be able to log into the school's electronic safe and view the documents in the compartment named after John's son in case of emergency. John has set the notify access field B12 of the access link to ‘yes’ so that he will receive an email each time the school authorities access the compartment.

The third access link E3 of the access link storage unit A7 provides John with access to a compartment of an electronic safe owned by a credit reporting company, In this example, the compartment, named ‘John Smith 123-456-789’ includes John's credit history. The credit reporting company has given unlimited view access to John at a per-access cost of $10. In this exemplary embodiment, each time John logs into his electronic safe, he will be given the option of selecting this compartment. Each time John selects this compartment, he will be prompted to accept or decline the $10 fee. If he accepts, he can view the information contained in this compartment after the electronic money transfer system A3 has deducted $10 from an account owned by John and deposited it into an account owned by the credit reporting company.

The fourth access link E4 of the access link storage unit A7 provides John with access to a compartment of an electronic safe owned by a property registrar. In this example, the compartment includes John's house deed in electronic format. Using this access link allows John to view this document an unlimited number of times for one year for a one-time fee of $50. The first time John views a document in the compartment, the system prompts him to accept the $50 fee. Once this fee has been paid, John can view the documents in the compartment at no additional cost until the access link expires.

The embodiments of the methods described above may be implemented in hardware or software, or a combination of both. However, preferably, these embodiments are implemented in computer programs executing on programmable devices. Program code is applied to input data to perform the functions described herein and generate output information. The output information is applied to one or more output devices, in known fashion.

Each program is preferably implemented in a high level procedural or object oriented programming and/or scripting language. However, the programs can be implemented in assembly or machine language, if desired. In any case, the language may be a compiled or interpreted language.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for providing secure electronic storage to a plurality of customers, the system comprising:
a safe generation module for generating a plurality of electronic safes, wherein each electronic safe in the plurality of electronic safes has an associated customer identifier for identifying the customer controlling the electronic safe;
a compartment generation module for generating a plurality of compartments in each electronic safe;
a compartment management module for storing one or more electronic documents in one or more of the electronic compartments in a specified safe;
an access generation module for, for each electronic compartment in the specified safe:
i) defining at least one access condition; and
ii) storing, in association with the electronic compartment, at least one access holder identifier for identifying an access holder;
an authentication module for determining if an authentication condition is met, the authentication module being operable to:
i) receive an authentication request from a user including identifying information; and
ii) verify the identity of the user based on the identifying information; and
an access control module for, if the authentication condition has been met:
i) determining a user identifier associated with the user;
ii) granting access to a requested electronic compartment of a requested electronic safe if the at least one access condition for the requested electronic compartment is met, wherein the at least one access condition comprises a requirement that the user identifier be an access holder identifier stored in association with the requested electronic compartment;
iii) denying access to the requested electronic compartment if the at least one access condition for the requested electronic compartment is not met;
iv) for each electronic safe in the plurality of electronic safes, checking if the user identifier is the associated unique customer identifier for that electronic safe, and granting access to the compartment generation module, the compartment management module and the access generation module in relation to that electronic safe if the user identifier is the associated unique customer identifier for that electronic safe.

2. The system of claim 1, wherein the at least one access holder identifier stored by the access generation module identifies an access holder other than the customer controlling the electronic safe.

3. The system of claim 2, wherein each access holder is a customer in the plurality of customers such that the plurality of electronic safes includes at least one electronic safe having an associated customer identifier identifying that access holder.

4. The system of claim 1, wherein the access control module is further operable for, if the access condition has been met, granting access to the compartment generation module, the compartment management module and the access generation module in relation to each electronic safe in the plurality of electronic safes if and only if the user identifier is the associated unique customer identifier for that electronic safe.

5. The system of claim 1, wherein
each electronic compartment has a unique electronic compartment identifier, the access generation module is further operable to define and maintain an access directory for each electronic compartment, the access directory comprising one or more access links, each access link comprising a plurality of access fields,
the plurality of access fields comprises
i) a compartment identifier field containing the electronic compartment identifier of an identified electronic compartment, and
ii) an access holder identifier field containing the access holder identifier of an identified access holder.

6. The system of claim 5, wherein the at least one access condition for the requested electronic compartment comprises the access holder identifier stored in the access holder identifier field of an appropriate access link matching the user identifier.

7. The system of claim 6, wherein
one or more of the access fields is an access type field defining the type of access authorized for the identified authorized access holder, and
the access control module is further operable to restrict the access granted according to the access type fields of the appropriate access link.

8. The system of claim 7, wherein the type of access is one or more of viewing, uploading, updating, creating, downloading, and deleting.

9. The system of claim 6, wherein one of the access fields is an access limit number field defining a specific number of times that the identified authorized access holder is authorized to access the identified electronic compartment,
the access control module is further operable to grant access to the requested electronic compartment only if the access limit number field of the appropriate access link is greater than zero, and
the access control module is further operable to update the access limit number field of the appropriate access link after granting access to the requested electronic compartment.

10. The system of claim 6, wherein one of the access fields is a start date and time field defining a date and time before which the access link associated with this access field is inoperable to provide access, and
the access control module is further operable to determine the current date and time and to grant access to the requested electronic compartment only if the start date and time field of the appropriate access link contains a date and time which is prior to the current date and time.

11. The system of claim 6, wherein one of the access fields is an end date and time field defining a date and time after which the access link associated with this access field is inoperable to provide access, and
the access control module is further operable to determine the current date and time and to grant access to the requested electronic compartment only if the end date and time field of the appropriate access link contains a date and time which is after the current date and time.

12. The system of claim 6, wherein one of the access fields is an access fee field defining one or more amounts to be charged to the identified authorized access holder to access the identified electronic compartment using the appropriate access link,
the system further comprises a billing module for
(i) receiving a request from the access control module to bill the user a requested amount, and
(ii) billing the user the requested amount, and
the access control module is further operable to send a request to the billing module to bill the user an appropriate amount before granting access to the requested electronic compartment.

13. The system of claim 12, wherein
the billing module is further operable to send a response to the access control module if the billing was successful and
the access control module is further operable to grant access to the requested electronic compartment only if a response is received from the billing module indicating that the billing was successful.

14. The method of claim 13, wherein the one or more amounts comprises a per-access fee to be charged each time the identified electronic compartment is accessed using the appropriate access fee.

15. The method of claim 13, wherein the one or more amounts comprises a first-access fee to be charged the first time the identified electronic compartment is accessed using the appropriate access link, and
the access control module is further operable to change the first-access fee to zero after granting access to the requested electronic document.

16. The system of claim 6, wherein each electronic compartment identifier comprises a unique safe identifier for identifying the electronic safe and a compartment identifier for identifying the identified electronic compartment within the electronic safe.

17. The system of claim 6, wherein the access generation module is further operable for:
(i) generating new access links;
(ii) deleting existing access links; and
(ii) modifying one or more access fields of existing access links.

18. The system of claim 12, the system further comprising an interface module for allowing access to the electronic safe through an electronic money transfer system.

19. The system of claim 18, wherein the authentication module is implemented by the electronic money transfer system.

20. The system of claim 18, wherein the electronic money transfer system includes the ability to withdraw funds from user accounts and to deposit funds into user accounts.

21. The system of claim 20, wherein each access holder has at least one user account in the electronic money transfer system.

22. The system of claim 21, wherein billing the user the requested amount comprises deducting the requested amount from a user account held by the user through the electronic money transfer system.

23. The system of claim 22, wherein each customer has at least one user account in the electronic money transfer system.

24. The system of claim 23, wherein the billing module is further operable, to deposit the requested amount into a user account held by the customer controlling the requested electronic safe through the electronic money transfer system.

25. The system of claim 23, wherein the billing module is further operable to periodically withdraw a safe administration fee from a user account held by a particular customer.

26. The system of claim 25, wherein the billing module is further operable to, if there are not enough funds in the user account held by the particular customer to cover the safe administration fee, prevent the access control module from performing one or more of its tasks in relation to one or more electronic safes controlled by the particular customer.

27. The system of claim 18, wherein the electronic money transfer system is administered by a trusted entity.

28. The system of claim 27, wherein the trusted entity is a bank.

29. The system of claim 6, wherein one of the access fields is a notify access field indicating whether or not the customer controlling the identified electronic compartment wants to receive a notification each time an attempt is made to access the identified electronic compartment using this access link, and the access control module is further operable to send a notification to the customer identified in the customer identifier field of the appropriate access link after access has been granted or denied to the user.

30. A method of providing secure electronic storage to a plurality of customers, the method comprising:
(a) for each customer in the plurality of customers, receiving an application for an electronic safe;
(b) providing a plurality of electronic safes by, for each customer in the plurality of customers, granting an electronic safe to that customer, the electronic safe including a customer identifier identifying that customer;
(c) determining if an authentication condition has been met by:
(i) receiving an authentication request from a user including identifying information; and
(ii) verifying the identity of the user based on the identifying information;
(d) if the authentication condition has been met, determining a user identifier associated with the user;
(e) generating a plurality of electronic compartments for each electronic safe by, if the authentication condition has been met:
(i) receiving a request from the user to create a new electronic compartment in a requested electronic safe;
(ii) verifying that the user identifier matches the customer identifier of the requested electronic safe; and
(iii) if the user identifier matches the customer identifier of the requested electronic safe, creating the new electronic compartment in the requested electronic safe;
(f) for each electronic compartment in the plurality of electronic compartments in each electronic safe in the plurality of electronic safes, defining at least one access condition;
(g) for each electronic compartment in the plurality of electronic compartments in each electronic safe in the plurality of electronic safes, storing, in association with that electronic compartment, at least one access holder identifier identifying an access holder by, if the authentication condition has been met:
(i) receiving a request from the user to authorize access to a requested electronic compartment in the requested electronic safe by a specific access holder;
(ii) verifying that the user identifier matches the customer identifier of the requested electronic safe; and
(iii) if the user identifier matches the customer identifier of the requested electronic safe, storing, in association with the requested electronic compartment, the access holder identifier identifying the specific access holder; and
(h) controlling access to the plurality of electronic safes by, if the authentication condition has been met:
(i) granting access to a requested electronic compartment of a requested electronic safe if the at least one access condition for the requested electronic compartment is met, wherein the at least one access condition comprises a requirement that the user identifier be an access holder identifier stored in association with the requested electronic compartment; and
(ii) denying access to the requested electronic compartment if the at least one access condition for the requested electronic compartment is not met.

31. The method of claim 30, the method further comprising:
(i) adding a plurality of electronic documents to the plurality of electronic safes by, if the authentication condition has been met:
(i) receiving a request from the user to add a specific electronic document to the requested electronic compartment in the requested electronic safe;
(ii) verifying that the user identifier matches the customer identifier of the requested electronic safe; and
(iii) if the user identifier matches the customer identifier of the requested electronic safe, storing the specific electronic document in the requested electronic compartment.

32. The method of claim 30, wherein
step (e) further comprises providing a unique electronic compartment identifier for each electronic compartment,
step (g)(iii) comprises defining one or more access links, wherein defining one or more access links comprises, for each access link,
(A) defining a compartment identifier field identifying the requested electronic compartment, and
(B) defining an access holder identifier field identifying the specific access holder.

33. The method of claim 32, wherein providing a unique electronic compartment identifier comprises providing a unique safe identifier for identifying a specific safe in which the compartment is located and a compartment identifier for identifying the identified electronic compartment within the specific safe.

34. The method of claim 32, wherein, in step (f), defining at least one access condition comprises requiring that the access holder identifier field of an appropriate access link match the user identifier.

35. The method of claim 34, wherein defining one or more access links further comprises, for each access link, defining the type of access granted to the specific access holder and
step (i)(i) further comprises determining the type of access granted to the user in the appropriate access link and granting only that type of access.

36. The method of claim 35, wherein the type of access is one or more of viewing, uploading, updating, creating, downloading, and deleting.

37. The method of claim 34, wherein defining one or more access links further comprises, for each access link, defining a limit number denoting the number of times the specific access holder can access the requested compartment and,
in step (f), defining at least one access condition further comprises requiring that the appropriate access link have a limit number which is greater than zero.

38. The method of claim 34, wherein defining one or more access links further comprises, for each access link, defining a start date and time at which the specific access holder can start accessing the requested electronic compartment,
in step (f), defining at least one access condition further comprises requiring that the start date and time of the appropriate access link be before a current date and time, and
step (i) further comprises determining the current date and time.

39. The method of claim 34, wherein defining one or more access links further comprises, for each access link, defining an end date and time after which the specific access holder can no longer access the requested electronic compartment based on the corresponding access link,
in step (f), defining at least one access condition further comprises requiring that the end date and time of the appropriate access link be after a current date and time, and
step (i) further comprises determining the current date and time.

40. The method of claim 34, wherein step (i) further comprises:
(iii) updating access fields of the appropriate access link.

41. The method of claim 34, the method further comprising maintaining an access log of attempts at accessing each electronic compartment and wherein step (i) further comprises:
(iv) updating the access log.
